(19) United States
(12) Patent Application Publication
(10) Pub. No.: US 2017/0094428 A1
(43) Pub. Date: Mar. 30, 2017

(54) SHOCK RESISTANT RECEIVER AND METHOD OF MANUFACTURING THE SAME

(71) Applicant: Knowles Electronics, LLC, Itasca, IL (US)

(72) Inventors: Randall A. Sanecki, Bensenville, IL (US); Scott Miller, Chicago, IL (US)

(21) Appl. No.: 15/371,946

(22) Filed: Dec. 7, 2016

Related U.S. Application Data
(63) Continuation of application No. 13/867,836, filed on Apr. 22, 2013.
(60) Provisional application No. 61/636,789, filed on Apr. 23, 2012.

(51) Int. Cl. H04R 25/00

(52) U.S. Cl. CPC H04R 25/604; H04R 25/65; H04R 2225/025

(57) ABSTRACT

An acoustic apparatus includes an outer housing, a receiver, and a shock cushion. The receiver is disposed within the outer housing. A plurality of viscoelastic members is disposed at least partially between the outer housing and the receiver. The plurality of viscoelastic members are sufficient to dampen mechanical energy received at the outer housing before reaching the receiver housing.

### CROSS REFERENCE TO RELATED APPLICATIONS

This application is a continuation of U.S. application Ser. No. 13/867,836, filed Apr. 22, 2013, entitled “Shock Resistant Receiver and Method of Manufacturing the Same” which claims benefit under 35 U.S.C. §119(e) to U.S. Provisional Application No. 61/636,789, filed Apr. 23, 2012, entitled “Shock Resistant Receiver and Method of Manufacturing the Same” the contents of which are incorporated herein by reference in its entirety.

### TECHNICAL FIELD

This application relates to acoustic devices and the ability of these devices to absorb various types of mechanical forces or shocks.

### BACKGROUND

Various types of acoustic devices have been used through the years. One type of acoustic device is a receiver. Generally speaking, a receiver receives an electrical signal that represents a sound, and converts the electrical signal into sound energy for presentation to a listener. Typically, the receiver includes a reed, a diaphragm, magnets, and a yoke. Other parts of combination of parts may also be used. In many receivers, vibration of the reed moves the diaphragm and this, in turn, creates the sound energy. The sound energy exits through a port in the device where it can be heard by a listener.

The receiver may be housed in an outer housing unit. This disposition may be motivated and desired so as to protect the receiver from various environmental elements or forces. For example, a receiver may be subjected to various mechanical forces and the outer housing unit may protect the receiver from these forces.

The environmental and mechanical forces often adversely impact the receiver and/or its proper functioning. More specifically, the receiver components are often very fragile and can become easily damaged. Even if the components are not damaged, the receiver operation can be significantly degraded because of these problems.

Previous approaches of isolating vibration and increasing shock protection have been used in Behind the Ear (BTE) hearing aid devices (the devise is positioned behind the patients ear) is to attach a flexible rubber tube (approximately 40-60 shore A hardness) to the sound port of the receiver and allow the receiver to freely move in the housing. An air gap between the receiver and the receiver's housing can be as large as 1.0 mm or more. The receiver is seldom mounted or attached to the housing wall, mounted by the sound port only. The cavity where the receiver is housed typically has rubber standoffs (approximately 40-60 Shore A hardness) so that if the receiver were to move far enough to contact the housing wall, it would contact the rubber standoffs. These standoffs perform two purposes. The first purpose is to reduce any noise that would occur from the receiver contacting the hard plastic BTE shell and transferring the noise into the microphone. The second purpose is to give a small amount of shock protection to the receiver.

Although these previous attempts have been made in BTE devices, they can not be applied to many other types of devices. And even if successful in BTE devices, these attempts have tended to be complicated and costly to implement. As a result, general user dissatisfaction with these previous approaches has developed.

### BRIEF DESCRIPTION OF THE DRAWINGS

For a more complete understanding of the disclosure, reference should be made to the following detailed description and accompanying drawings wherein:

FIG. 1 comprises a side cutaway view of a receiver assembly;

FIG. 2 comprises a side view of the receiver assembly of FIG. 1;

FIG. 3 comprises a cross section view taken along line 115 of the receiver assembly of FIG. 1 and FIG. 2;

FIG. 4 comprises a side cutaway view of a receiver assembly that uses a gasket to seal one of its ends;

FIG. 5 comprises an end of the receiver assembly of FIG. 4;

FIG. 6 comprises an cross sectional view of the receiver assembly of FIG. 4 taken along the line A-A of FIG. 4;

FIG. 7 comprises a flow chart of one approach for constructing a receiver assembly;

FIG. 8 comprises a side cutaway view of a receiver assembly using a gasket;

FIG. 9 comprises an end of the receiver assembly of FIG. 8.

Those of ordinary skill in the art will appreciate that elements in the figures are illustrated for simplicity and clarity. It will be appreciated further that certain actions and/or steps may be described or depicted in a particular order of occurrence while those having ordinary skill in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Acoustic devices are provided that include ways for dampening energy transferred through a receiver housing before reaching the internal components of the receiver (e.g., its diaphragm, magnets, reed, to mention a few examples). The approaches described herein are easy and cost effective to implement and sufficiently dampen energy that impacts an outer receiver housing before the energy can negatively impact the operation or functionality of the receiver disposed within the outer housing.

On a Receiver in Ear (RIE) device, the receiver is housed in a plastic outer shell and inserted directly into the patient's ear canal. In contrast to a Behind the Ear (BTE) housing, the size of the receiver housing used on a RIE is designed to fit around the receiver as tight as possible. The size and shape of the ear canal that the device fits in varies from patient to patient, but the average adult ear canal size is approximately 2.5 cm long and 0.7 cm diameter and has a sigmoid form. The size of a receiver used in a hearing aid device can be as large as 7.87 mm 4.09 mm 2.79 mm and as small as 5.00 mm×2.73 mm×1.93 mm. The larger the receiver size, the higher the sound output, although the larger size also results in lower patient fit rates. If used in RIE devices, the previous suspension methods used in BTE devices (described above) would drastically reduce patient fit rates. The approaches described herein provide receiver shock resistance in RIE devices while adding only approximately 0.10 mm to the overall diameter of the part and only marginally effecting patient fit rates.

In many of these embodiments, an outer housing and a front cap are ultrasonically welded or glued together. The outer housing includes a receiver (itself including elements such as a diaphragm, reed, and magnets) that is disposed within the outer housing. A shock cushion is provided in the event of the unit being dropped or struck by some mechanical force. In one aspect, the receiver is attached to the interior of the outer housing at a plurality of points (e.g., nine points). For instance, a viscoelastic material may be injected through small holes in the side of the housing to create some of the points (e.g., eight of the points). The viscoelastic filler material described herein has one advantage of reducing the amount of vibrations, created by the receiver, that can transfer through the assemblies housings and connector assembly back to the microphone that is typically housed in the Behind The Ear (BTE) shell section of the hearing aid instrument.

The other contact/support point or points between the receiver and the housing may be disposed at various locations. In one aspect, a gasket is disposed between the front of the receiver and housing to create another contact point or contact area. The gasket is preferably in place before the welding occurs. In another aspect, a soft acrylic or silicone sealing the front of the receiver to the housing is applied to create the other contact point.

The viscoelastic material is effective to dampen energy transferred through the housing before the energy reaches the receiver. Additionally, a gap (e.g., an air gap) exists between the receiver and inner housing walls and this gap allows for compression and displacement of the viscoelastic material.

In others of these embodiments, an acoustic apparatus includes an outer housing, a receiver, and a shock cushion. The outer housing is configured to be disposed and fit in the ear canal of a human user. The receiver is disposed within the outer housing. The shock cushion is disposed at least partially between the outer housing and the receiver. The shock cushion is sufficient to dampen mechanical energy received at the outer housing before reaching the receiver housing.

In some aspects, the shock cushion includes a plurality of shock absorbing members by which the receiver is attached to the outer housing. In some examples, each of the plurality of shock absorbing members is constructed of a viscoelastic material. Other examples of materials may be used.

In other aspects, a gasket is coupled to an end of the outer housing and the gasket is configured to further dampen mechanical energy received at the outer housing before reaching the receiver. In still other aspects, a gap is disposed between the outer housing and the receiver. In some examples, the gap is filled with air. In other examples, the gap is filled with a filler material.

In others of these embodiments, an acoustic apparatus includes an outer housing, a receiver, a plurality of viscoelastic shock absorbing members, a gap, and a gasket. The outer housing is configured to be disposed and fit in the ear canal of a human user. The receiver is disposed within the outer housing. The plurality of viscoelastic shock absorbing members are disposed at least partially between the outer housing and the receiver. The plurality of viscoelastic shock absorbing members are sufficient to dampen mechanical energy received at the outer housing before reaching the receiver housing. The gap is disposed between the outer housing and the receiver. The plurality of viscoelastic shock absorbing members are disposed at least partially within the gap. The gasket is coupled to an end of the outer housing. The gasket is configured to further absorb mechanical energy received at the outer housing before reaching the receiver.

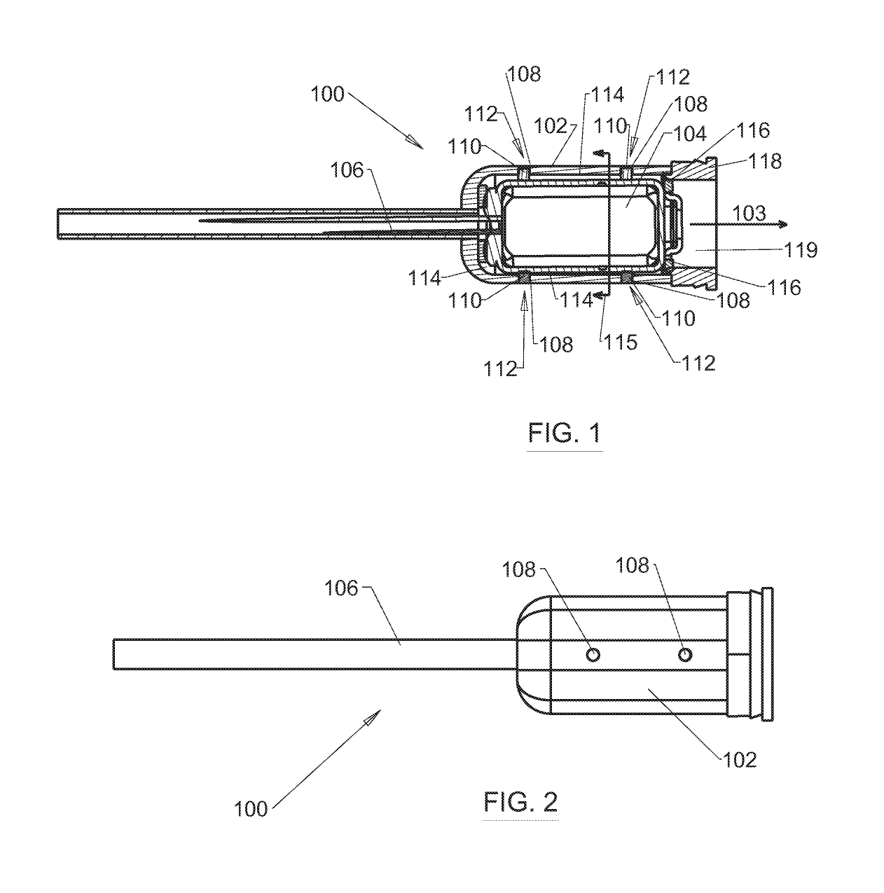

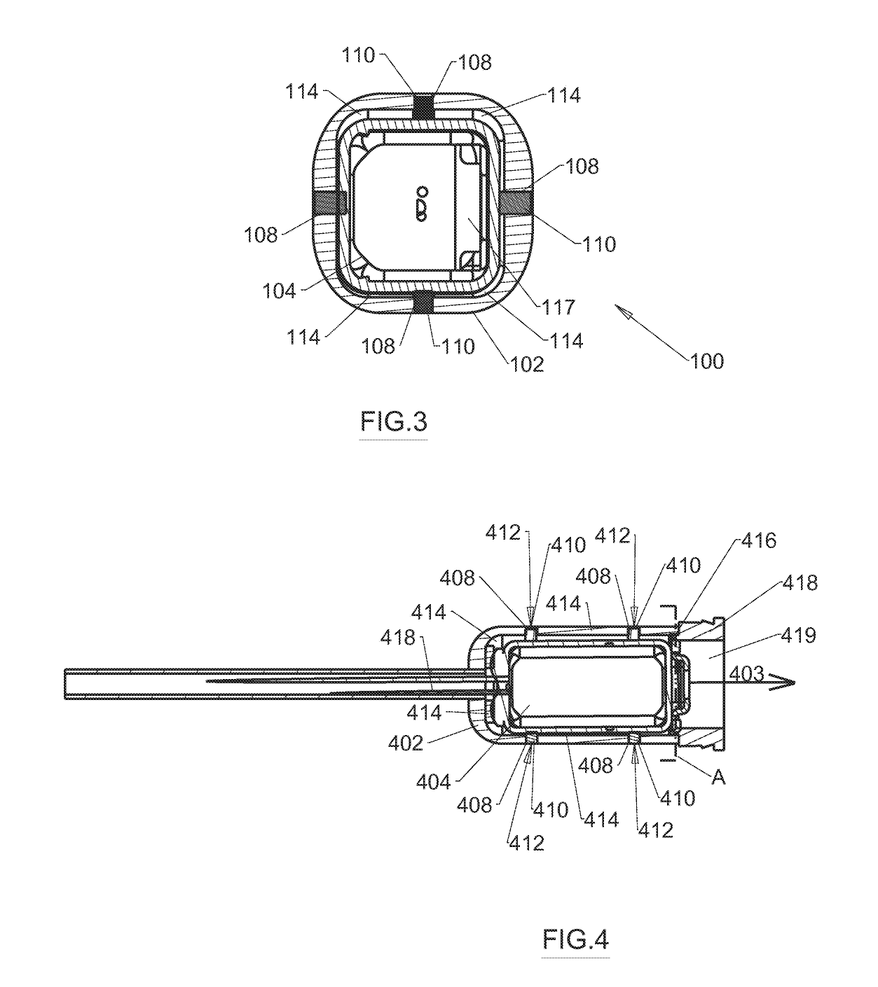

Referring now to FIGS. 1-3, one example of a receiver assembly 100 is described. The assembly 100 includes an outer housing 102 and an inner housing 104. The housings 102 and 104 may be constructed from plastic or some similar strong material.

The inner housing 104 includes components therein that together form and function as a receiver. These components may include a reed, diaphragm, magnets, magnetic yoke, and so forth. An electrical signal is received over wire 106 (e.g., litz wire) at the receiver housing 104. More specifically, the components within the receiver housing 104 receive this electrical signal over wires 106, and convert the electrical signal into sound energy for presentation to a listener. For example, for a receiver including a reed and diaphragm, the electrical signal acts to move the reed, thereby moving the diaphragm and this, in turn, creates the sound energy. The sound energy exits through a port 117 of the receiver 104 through opening 119 in the outer housing 102 in the direction indicated by the arrow labeled 103 where the sound can be heard by a listener. A front cap 118 is attached to the housing 104, for example by ultrasonic welding or use of adhesives.

The outer housing 102 has holes or openings 108 extending through the housing 102. A viscoelastic material 110 is injected through the holes 108 in the direction generally indicated by the arrows labeled 112. In one example, eight holes are used (e.g., two holes per side to inject soft acrylic of silicone).

An air gap 114 is formed and disposed between the outer housing 102 and the inner housing 104. The filler material 110 touches the inner housing 104 and holds the inner housing 104 in position with respect to the outer housing 102. The filler 110 does not fill the air gap 114.

The front of the housing 102 is sealed with a sealing material 116 (viscoelastic). Alternatively, as described elsewhere herein a gasket can be used as a seal after ultrasonic welding or adhesive attachment of the front cap to the housing 102. The sealing material 116 is effective to seal the air gap 114 from the exterior.

It will be appreciated that a shock cushion is created in the event of the unit being dropped or struck by some mechanical force. The filler material 110 and 116 creates part of the cushion and is effective to dampen energy transferred through the housing before the energy reaches the receiver housing 104. The air gap 114 between the receiver housing 104 and inner housing walls of outer housing 102 allows for compression of the device 100.

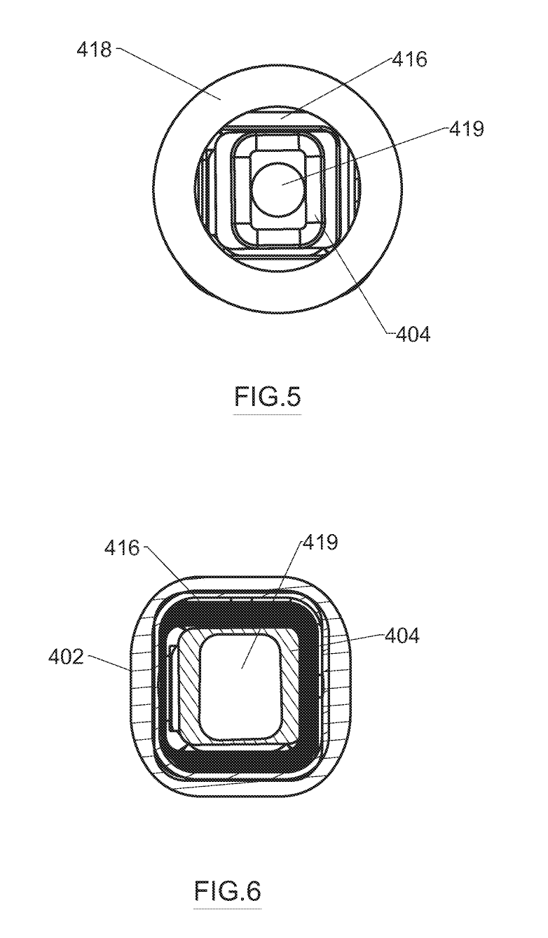

Referring now to FIGS. 4, 5, and 6 another example of a receiver assembly 400 is described. The assembly 400 includes an outer housing 402 and an inner housing 404. The housings 402 and 404 may be constructed from plastic or some similar construction material.

The inner housing 404 includes components that form and function as a receiver and these components may include a reed, diaphragm, magnets, magnetic yoke, and so forth. An electrical signal is received over wire 406 to the receiver housing 404. The components inside the receiver housing 404 receive this electrical signal over wires 406 (e.g., litz wire), and convert the electrical signal into sound energy for presentation to a listener. For example where the components include a reed and diaphragm, the electrical signal moves the reed, this moves the diaphragm, and this, in turn, creates the sound energy.

The sound energy exits through a port of the receiver 404 through opening 419 in the outer housing 402 in the direction indicated by the arrow labeled 403 where it can be heard by a listener.

The outer housing 402 has holes extending through the housing 402. A material 410 (e.g., a soft silicone or acrylic adhesive) is injected through the holes 408 in the direction generally indicated by the arrows labeled 412. In one example eight holes are used (e.g., two holes per side to inject soft acrylic of silicone).

An air gap 414 is disposed between the outer housing 402 and the inner housing 404. The filler material 410 touches the inner housing 404 and holds the inner housing 404 in position with respect to the outer housing. The filler 410 does not fill the air gap 414.

The front of the housing 402 is sealed with a gasket 416 can be used as a seal after ultrasonic welding or adhesive attachment of the front cap to the housing 402. A front cap 418 is attached to the housing 404, for example by ultrasonic welding or adhesive attachment, after the gasket 416 is attached. The gasket 416 is effective to seal the air gap 414 from the exterior.

It will be appreciated that a shock cushion is created in the event of the unit being dropped or struck by some mechanical force. The filler material 410 creates part of the cushion and is effective to dampen energy transferred through the housing 402 before the energy reaches the receiver housing 404. The air gap 414 between the receiver 404 and inner housing walls of housing 402 allows for compression of the device 400.

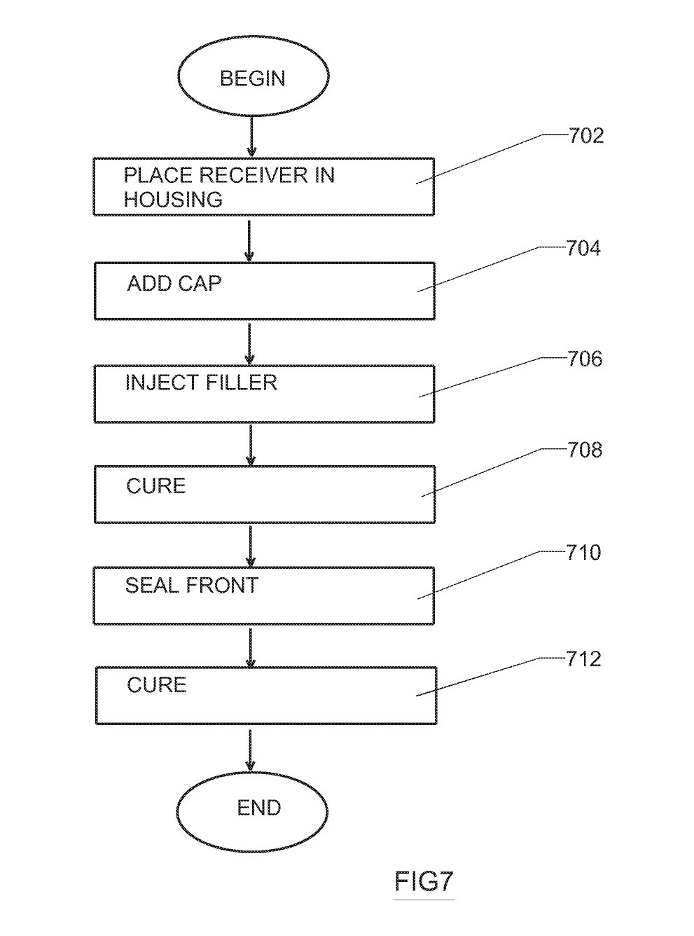

Referring now to FIG. 7, one example of an approach for manufacturing an acoustic device is described. At step 702, a receiver with litz wires is placed in a housing (e.g., within the housing 102). At step 704, an ultrasonic weld cap (e.g., cap 118) is applied to the housing allowing receiver to “free float.”

At step 706, a viscoelastic material is injected through the holes in the housing side (e.g., through holes 108). At step 708, the filler material is cured. At step 710, another filler material (e.g., a soft acrylic or silicone) is dispensed to seal front of receiver to housing and at step 712, this filler material is cured. Alternatively, an ultrasonic weld cap with gasket between receiver and cap may be used. The curing of the two filler materials may occur simultaneously or substantially simultaneously. The gasket or seal is effective to seal the air gap (formed in the interior of the device) from the exterior.

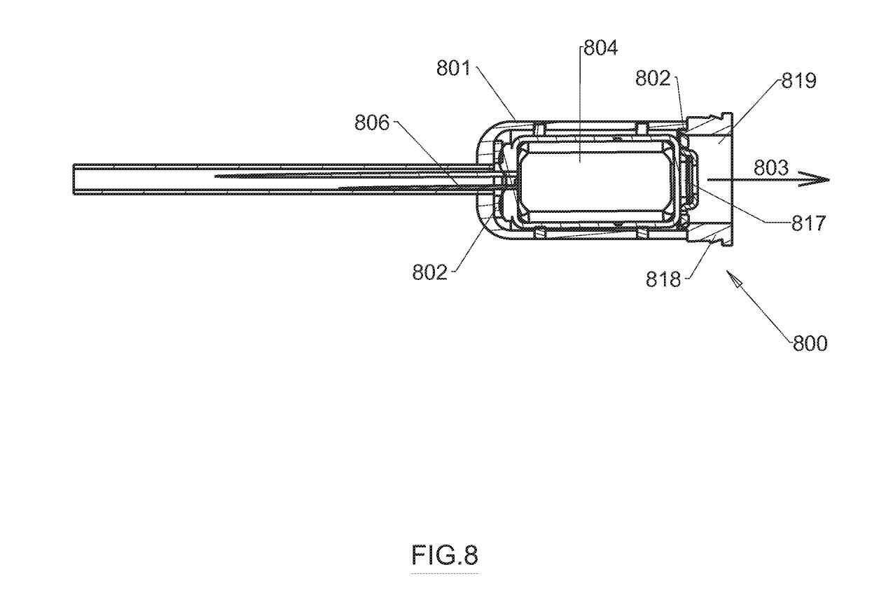

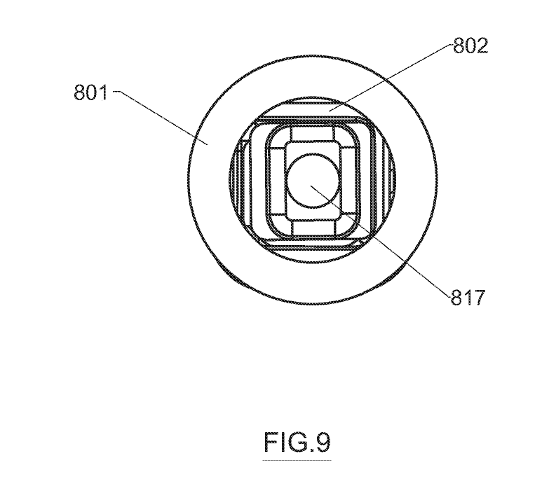

Referring now to FIGS. 8 and 9, one example of a receiver assembly 800 is described. The assembly 800 includes an outer housing 801 and an inner housing 804. The housings 801 and 804 may be constructed from plastic or some similar strong material.

The inner housing 804 includes components therein that together form and function as a receiver. These components may include a reed, diaphragm, magnets, magnetic yoke, and so forth. An electrical signal is received over wire 806 (e.g., litz wire) at the receiver housing 804. More specifically, the components within the receiver housing 804 receive this electrical signal over wires 806, and convert the electrical signal into sound energy for presentation to a listener. For example, for a receiver including a reed and diaphragm, the electrical signal acts to move the reed, thereby moving the diaphragm and this, in turn, creates the sound energy. The sound energy exits through a port 817 of the receiver 804 through opening 819 in the outer housing 801 in the direction indicated by the arrow labeled 803 where the sound can be heard by a listener. A front cap 818 is attached to the housing 804, for example by ultrasonic welding or use of adhesives.

In this case, the outer housing 801 has no holes or openings extending through the housing 801 for the injection of a viscoelastic material through holes in the outer housing. Instead, a gasket 802 is disposed between the inner housing and front cap 801 and 818 respectively. The gasket 802 is constructed of a viscoelastic material and is attached to the receiver 804 prior to inserting the receiver 804 into the inner housing 801. The gasket 802 is attached to the sound port side 817 of receiver 804 and also on the back side of the receiver 804. The cap 818 is then ultrasonic welded to the housing 801. The purpose of gasket 802 is to create a acoustic dampening suspension system for the receiver 804 that will isolate the receiver 804 from external vibrations and mechanical shocks, thus protecting the receiver 804 from damage that may occur from these external forces. The gaskets 802 also reduce any vibrations from the receiver 804 from transferring through the housing 801 and tube 802 back to the BTE shell section of a hearing instrument where a microphone may be housed, resulting in acoustic feedback.

Preferred embodiments of this disclosure are described herein, including the best mode known to the inventors for carrying out the disclosure. It should be understood that the illustrated embodiments are exemplary only, and should not be taken as limiting the scope of the appended claims.

What is claimed is:

1. An acoustic apparatus comprising:
an outer housing having a longitudinal axis, the outer housing being configured to fit within an ear canal of a human user, the outer housing having a plurality of openings extending there through and the openings being spaced about the longitudinal axis;
a receiver disposed within the outer housing, wherein the receiver is attached to the outer housing via a plurality of viscoelastic members; and
a gap between the receiver and the outer housing;
wherein the plurality of viscoelastic members are disposed at least partially between the outer housing and the receiver and wherein the plurality of viscoelastic members are constructed of a viscoelastic material that fills the openings and extends across the gap to contact the receiver, the members being configured to hold the receiver in place with respect to the outer housing during use of the acoustic apparatus.

2. The acoustic apparatus of claim 1 wherein the plurality of viscoelastic members are vibration reduction members.

3. The acoustic apparatus of claim 1 wherein the plurality of viscoelastic members are shock cushion members.

4. The acoustic apparatus of claim 1 wherein the gap is filled with air.

5. The acoustic apparatus of claim 1 wherein the gap is filled with a filler material.

6. An acoustic apparatus, comprising:
an outer housing having a longitudinal axis, the outer housing being configured to fit within an ear canal of a human user, the outer housing having a plurality of openings extending there through and the openings being spaced about the longitudinal axis;
a receiver disposed within the outer housing, wherein the receiver is attached to the outer housing via a plurality of viscoelastic members, wherein the plurality of viscoelastic members are disposed at least partially between the outer housing and the receiver;
a gap between the outer housing and the receiver, the plurality of viscoelastic members disposed at least partially within the gap; and
a gasket coupled to an end of the outer housing, the gasket configured to further absorb mechanical energy received at the outer housing before reaching the receiver;
wherein the plurality of viscoelastic members comprise viscoelastic material that is injected through and fills the openings and is configured to hold the receiver in place with respect to the outer housing during use of the acoustic apparatus, wherein after manufacturing each of the members extends through a selected opening and across the gap to contact the receiver.

7. The acoustic apparatus of claim 6 wherein the plurality of viscoelastic members are vibration reduction members.

8. The acoustic apparatus of claim 6 wherein the plurality of viscoelastic members are shock cushion members.

9. The acoustic apparatus of claim 6 wherein the gap is filled with air.

10. The acoustic apparatus of claim 6 wherein the gap is filled with a filler material.

11. An acoustic apparatus comprising:
an outer housing having a plurality of radial openings disposed about a longitudinal axis of the outer housing, the outer housing configured to fit within a human ear canal;
a receiver disposed within the outer housing;
a gap between an outer side of the receiver and an inner side of the outer housing; and
a plurality of viscoelastic members spaced apart in the gap, each of the viscoelastic members disposed at least partially in a corresponding radial opening and extending across the gap to contact the receiver, the plurality of viscoelastic members at least partially positioning and retaining the receiver relative to the outer housing,
wherein the plurality of viscoelastic members dampens mechanical energy received at the outer housing before the mechanical energy reaches the receiver.

12. The acoustic apparatus of claim 11 further comprising a gasket disposed about an axial portion of the receiver, the gasket located between an end of the receiver and an end of the outer housing.

13. The acoustic apparatus of claim 11, each of the plurality of viscoelastic members is an injection molded viscoelastic member.

14. The acoustic apparatus of claim 11 comprising a microphone in the outer housing and wherein the plurality of viscoelastic members reduces vibrations created by the receiver that transfer back to the microphone.
